(19) United States
(12) Patent Application Publication
(10) Pub. No.: US 2007/0038628 A1
(43) Pub. Date: Feb. 15, 2007

(54) System and method for exchanging documents

(75) Inventors: John J. Eckert, West Hartford, CT (US); Paul Eckert, Cheltenham, PA (US)

Correspondence Address: Ethan D. Civan, Suite 200, Two Penn Center Plaza, Philadelphia, PA, 19102-1706, US

(73) Assignee: Quixam, LLC

(21) Appl. No.: 11/203,027

(22) Filed: Aug. 12, 2005

(51) Int. Cl. G06F 17/30

(52) U.S. Cl. 707/9

(57) ABSTRACT

A method of delivering documents electronically, including prompting a first user at a first business to send a reference to a document to a second user at a second business over a secure network, verifying that the second business has rights to the document, and granting all users at the second business access to the document if the second business has rights to the document. In another aspect, a method of creating notes, including verifying that a user is a practitioner, prompting the practitioner to enter text, prompting the practitioner to submit the text as a portion of a permanent record, and if the practitioner submits the text, saving the text as a portion of a permanent record. In another aspect, a method of segregating data within a file into distinct patient documents, including identifying the beginning of each document by searching for one or more predetermined phrases, and storing each document.

### FIELD OF THE INVENTION

The present invention relates generally to document management. More particularly, it relates to sharing documents among multiple businesses.

### BACKGROUND

The management of electronic documents is an increasingly important task in businesses in general. In many businesses, moreover, a need exists to share documents between and among selected, authorized businesses. For example, in the medical field, it is extremely useful for physicians to share patient records with other physicians in other medical practices to aid in the treatment of their patients; however, it is crucial to prevent such records from being disclosed to unauthorized persons. It is also essential to comply with state and federal legislation and regulations, including the well known HIPAA act.

### SUMMARY OF THE INVENTION

A method of delivering documents electronically, including prompting a first user at a first business to send a reference to a document to a second user at a second business over a secure network, verifying that the second business has rights to the document, and granting all users at the second business access to the document if the second business has rights to the document.

In another aspect, a method of creating notes, including verifying that a user is a practitioner, prompting the practitioner to enter text, prompting the practitioner to submit the text as a portion of a permanent record, and if the practitioner submits the text, saving the text as a portion of a permanent record.

In another aspect, a method of segregating data within a file into distinct patient documents, including identifying the beginning of each document by searching for one or more predetermined phrases, and storing each document.

### BRIEF DESCRIPTION OF THE DRAWINGS

FIG. 1 is a block diagram of a system in accordance with a preferred embodiment of the present invention.

FIG. 2 is a flow chart illustrating a first method in accordance with a preferred embodiment of the present invention.

FIG. 3 is a flow chart illustrating a second method in accordance with a preferred embodiment of the present invention.

FIG. 4 is a flow chart illustrating a third method in accordance with a preferred embodiment of the present invention.

FIG. 5 is a flow chart illustrating a fourth method in accordance with a preferred embodiment of the present invention.

### DETAILED DESCRIPTION OF THE PREFERRED EMBODIMENTS

The following definitions are provided to aid in construing the claims of the present application:

BSC: A group of businesses, all of which businesses have at least one common customer. A first business can be BSC with respect to a second business relating to a first customer but not be BSC with respect to that business relating to a second customer.

Circle of Sharing: A group of businesses that are BSC with respect to a particular customer and that share certain documents relating to such customer, each business having affirmatively elected to join with respect to that customer. Each member of the Circle of Sharing is granted access to unrestricted documents published by other members relating to such common customer.

Document: For the purposes of the present application, an electronic file, such as, for example, a pdf or html file, containing text, images, sound, or video, among other formats, or any combination of such (or other) formats, whether or not additional matter is present in the file. The document can but need not be a scanned paper document or the electronic equivalent of a paper document.

Global: For purposes of the present application, global encompasses all published documents with granted permissions available to a business.

Grant Access/Send Reference: For purposes of the present application, granting access to data shall include granting access to data, such as by providing a database permission, password, or other means of accessing local or remote data or documents, sending a reference or a link to documents or data, sending original data or documents or copies thereof, or any other means of providing the contents of the applicable documents or data to the relevant individual or other entity. Sending a reference shall have the same meaning as granting access for purposes of the present application.

HIPAA: The Health Insurance Affordability and Accountability Act of 1996, as amended.

Hospital: For the purposes of the present application, any hospital or subdivision thereof, including a hospital department, such as a radiology department.

Limited: A user or class of users have limited rights when such users have a subset of the otherwise available rights with respect to documents or other data. For example, a user can be limited to accessing data relating to one or more customers or practitioners only. Other users can be limited to being only able to load data, but not to view data, or to view data, but not to load data. In some embodiments hereunder, limited rights are applicable only at the local level, while in other embodiments, they are also applicable at the global level.

Local: For purposes of the present application, local encompasses only documents uploaded, stored on, or otherwise provided to a system by a business and not documents uploaded, stored on, or otherwise provided to the system by other businesses.

Permanent Record: Documents that are published and identified to relate to the business customer.

Practitioner: For purposes of the present application, any individual granted authority by a practice to author a document, including a health care professional, such as a physician, physician's assistant, or nurse practitioner.

Provider of Nursing Services: For the purposes of the present application, any entity providing nursing services that is not a hospital or a medical practice. For example, this term includes nursing homes and home health care agencies.

Publication: For purposes of the present application, a document is published when it is uploaded, stored, or otherwise provided to a secure medium, whether or not access to the document is ever granted to any other business or person and even if the document is marked as restricted.

Restricted: For purposes of the present application, a document is restricted if the business publishing it marks it as restricted at the time of publication or at a subsequent time and remains restricted until such time as such business marks it as no longer restricted (or “unrestricted”).

Secure Medium: Any computerized storage system, including but not restricted to a database system, that includes safeguards to prevent unauthorized users from gaining access to such system, whether or not such safeguards are completely effective. Preferably, secure file transport methods are utilized for uploading and downloading data to the secure medium.

Tombstone: An indication of status as a prior member of a Circle of Sharing. Grayed out text, for example, can be used as a Tombstone.

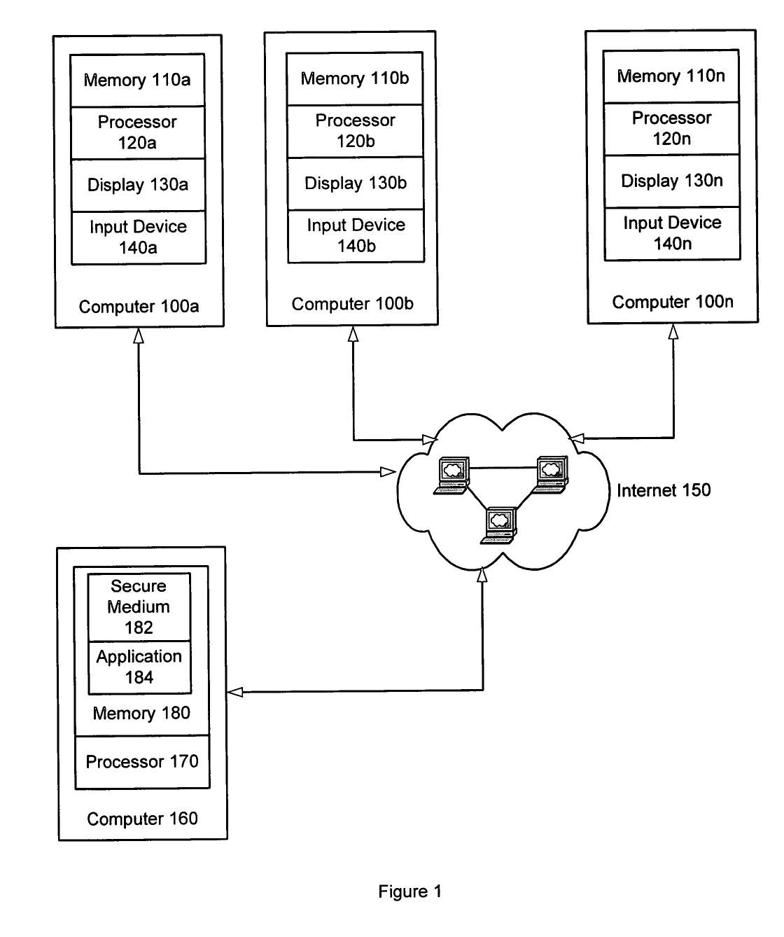

Referring generally to FIGS. 1 through 5, in certain preferred embodiments of the present invention, documents can be exchanged through granting database permissions either on an explicit share or an implicit share basis. In an explicit share, a first user designates the sharing user or users. This designation can be accomplished by selecting such user or users from a list and simply granting the requisite database rights, by sending references to the documents by a secure form of e-mail, or by other means. In an implicit share, a second user obtains rights to one or more documents automatically. For example, the second user can obtain such rights as a result of the first user obtaining such rights or as a result of the first user providing such one or more documents to a database. A Circle of Sharing is a form of implicit share.

Referring specifically to FIG. 1, a system in accordance with a preferred embodiment of the present invention is illustrated. Computers 100a through 100n are located at or used by businesses participating in an embodiment of the present invention. Each of computers 100a through 100n includes at least memory 110, processor 120, display 130, and input device 140. Memory 110 can be permanent storage, such as a hard drive, temporary memory, such as random access memory (RAM), or a combination thereof. Processor 120 can be any Pentium processor, although other microprocessors can also be used, including microprocessors used MacIntosh and PocketPC computers, for example. Display 130 can be a standard cathrode ray tube (CRT) monitor or liquid crystal display (LCD), such as a standard seventeen inch color CRT monitor, although a wide array of displays can be used. Input device 140 can be a keyboard, keypad, writing tablet, mouse, trackball, touchpad, touchscreen, microphone for a voice control system, or other input device, although a combination of keyboard and mouse is widely available. A Dell Pentium 4 desktop system such as the Dell Dimension 3000 is an example of one of many computers that would be satisfactory under many embodiments for use as computer 100(a-n). In certain embodiments hereunder, computer 100(a-n) should be capable of running an Internet browser and plug-ins, such as Adobe Acrobat Reader.

Computer 160 is one or more computers including memory 180 and processor 170. Memory 180 includes permanent storage, such as (but not limited to) a hard drive. Processor 170 can be any Pentium processor, although other microprocessors can also be used. A Dell Pentium 4 desktop system such as the Dell Dimension 3000 is an example of one of many computers that would be satisfactory under many embodiments for use as computer 160. Computer 160 is a centralized server that can optionally be hosted at multiple sites.

Computers 100a through 100n and computer 160 are connected to Internet 150. Each computer can be connected in the same manner or some computers can be connected differently. Computers 100a through 100n and 160 can be connected by dialup modem, by broadband connection (such as cable modem, ISDN, T-1, or T-3), or indirectly through a network to a computer that is connected to the Internet.

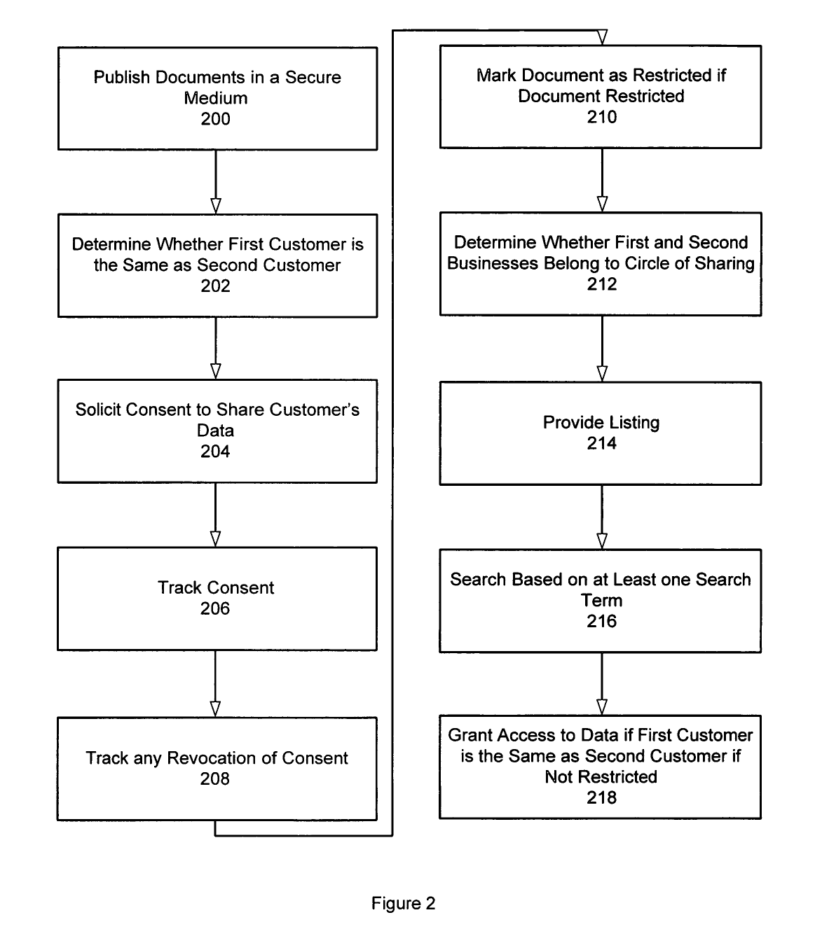

Memory 180 includes a secure medium 182, which is used to store documents to be exchanged among multiple businesses as described below with respect to the method illustrated in FIG. 2. Secure medium 182 can be a relational database, such as Oracle Database 10g or Microsoft SQL Server 2000 Enterprise Edition, a distributed database, or even (particularly in the case of a group of businesses using comparatively few documents) a simple collection of files in a directory tree format, such as an operating system directory tree format (provided that there are adequate protections against unauthorized access). In some embodiments, data is stored using structured data types. Any other type of secure medium can also be used. A document is published to the secure medium by uploading it securely to the secure medium or otherwise storing it on or providing it to the secure medium. Memory 180 also includes application 184, which implements the method illustrated in FIG. 2. In some embodiments hereunder, a portion of application 184 is instead stored in memories 110. For example, the user interface relating to the method can be stored locally in memories 110a through 110n while the remainder of the application is stored in memory 180.

In alternative embodiments of the present invention, computers 100a through 100n can connect to computer 160 by means other than the Internet, such as through a network or by direct modem to modem communication. In yet other embodiments of the present invention, computer 160 is not present and computers 100a through 100n communicate directly with each other (by means of the Internet or otherwise). In yet other embodiments, only a single computer is used and all data is stored on it.

Referring to FIG. 2, a flow chart illustrating a method in accordance with a preferred embodiment of the present invention is set forth. In step 200, one or more documents relating to a first customer of a first business are published in a secure medium. The business, which can, but need not, be a medical practice, can publish one, some, or all of its documents relating to a particular customer. It can also, but need not, at the same time publish documents relating to other customers.

In step 202, it is determined whether the first customer of the first business is the same person as a second customer of a second business. The first and the second business can, but need not, be in the same field. For example, the first and second business can both be medical practices, or the first business can be a medical practice and the second business can be a pharmacy, laboratory, health insurance company, etc. The first and second customers can, but need not, be patients.

In some implementations of the present invention, published documents or references thereto are sent to other businesses when specifically directed to such businesses, such as, for example, by attaching such documents or references thereto to a secure form of electronic mail, as is described below. In other implementations of the present invention, published documents or references thereto are sent to other businesses by means of a Circle Of Sharing as is also detailed below. In the first case, it is only necessary to check whether the recipient business (or the business employing the recipient) has a customer who is the same person as the first customer. One method of determining whether the first and second customers are the same person is described below. In the second case, it is necessary to perform this check with respect to each member of the Circle Of Sharing. This can be accomplished, for example, by verifying whether each customer is a member of a Circle Of Sharing with respect to the first customer.

In step 204, the customer's consent to the sharing of his or her data is solicited. In the medical context, this comprises requesting that each patient of each medical practice consent to the sharing of such patient's medical records at that medical practice. This consent can be solicited by means of a written or digital form, especially a form requesting that the patient waive certain protections as authorized by HIPAA. In some embodiments of the present invention, consent is solicited repeatedly, evenly if previously granted. In certain embodiments of the present invention, step 204 is omitted.

In step 206, whether a customer has consented to the sharing of his or her data is tracked. Such consent can be tracked by entering into a database whether a customer has consented to share or refused each time the customer is solicited. In certain embodiments of the present invention, step 206 is omitted, especially in embodiments in which step 204 is omitted.

In step 208, if a revocation of any previously granted consent to the sharing of a customer's data is received, such revocation is tracked. Such revocation can also be tracked by means of a database entry. In certain embodiments of the present invention, step 208 is omitted, especially in embodiments in which step 204 is omitted.

In some embodiments of the present invention, if a customer does not consent to the sharing of his or her data, or revokes a previously granted consent, access is denied to (a) all documents relating to such customer published after the refusal or revocation and (b) all documents relating to such customer published before the refusal or revocation but not shared with any other business. In other embodiments, such refusal or revocation has no effect. In other embodiments, such refusal or revocation applies only to documents marked as restricted. In yet other embodiments, the effect of such refusal or revocation is determined by each business. For example, in the medical context, HIPAA restricts the sharing of patient documents without patient consent; however, a practitioner retains the right to share patient documents without patient consent in limited circumstances in the course of patient treatment. Thus, in certain embodiments of the present invention, providing flexibility to each business can be usefull.

In step 210, a document can be marked as restricted by a business. A specific document can be marked as restricted, all documents relating to a patient can be marked as restricted, or all documents of a certain type (such as HIPAA consent forms and administrative documents). In some embodiments of the present invention, marking a document as restricted prevents it from being shared at all outside the local business. In other embodiments, a restricted document is shared unless consent to share is refused or revoked. In other embodiments, step 210 is not performed or if performed has no effect.

In step 212, it is determined whether the first and second businesses are members of a Circle Of Sharing. Step 212 can be performed by verifying the underlying facts or by verifying status, for example, by performing a database lookup if the underlying facts have previously been determined. If a Circle Of Sharing exists with respect to the first customer and the first and second businesses are both members of it, then in step 218, not only are the currently published documents shared, but in many embodiments, other documents relating to the same customer as well. In some embodiments, all unrestricted documents previously, concurrently, or subsequently published by either the first or second businesses are shared between the first and second businesses; in addition, unrestricted documents previously, concurrently, or subsequently published by other businesses that are members of the Circle Of Sharing are provided to the first and second businesses as well. Moreover, unrestricted documents, whenever provided, authored by non-members of the Circle Of Sharing, but provided to one or more members of the Circle Of Sharing are also provided to the first and second businesses. Finally, any other documents, such as restricted documents that were nevertheless shared, whenever provided, authored by non-members of the Circle Of Sharing, but provided to one or more members of the Circle Of Sharing are also provided to the first and second businesses. In different embodiments of the present invention, different subsets of the above documents are shared or provided among members of a Circle Of Sharing. While maximal sharing of documents is appropriate in certain embodiments hereunder, in others a lesser degree of sharing is more desirable. In certain embodiments of the present invention, step 212 is omitted.

In step 214, a listing of one or more of all of the businesses, employees, or practitioners, or a subset of one or more thereof, listed in a database in the secure medium can be published on the secure medium. Examples of subsets include all practices or all physicians in a particular Circle Of Sharing. However, in some embodiments hereunder, in order to satisfy specific concerns, such as privacy concerns arising under HIPAA, certain listings can only be visible to defined individuals. For example, listings of practices or physicians participating in a particular Circle Of Sharing are only provided to members of the same Circle Of Sharing. In one preferred embodiment, listings of practices participating in a particular Circle Of Sharing include the names of practices formerly participating in that Circle Of Sharing (such as in the form of a tombstone), but such names of formerly participating practices are only provided to, or made visible to, practices participating in a Circle Of Sharing that at the time of the provision of the listings of practices include at least one practice participating in such Circle of Sharing at the time of participation of such former participants. In certain embodiments of the present invention, step 214 is omitted.

In step 216, a search can be performed of either global or just local documents based on at least one search term entered by a user, such as a practitioner. The search term or terms can include a term related to the customer's identity (such as the customer's name, social security number, etc.), a term relating to a class of documents (such as the name of a type or class of test), a term relating to a customer problem (such as a patient diagnosis), a term relating to a customer source (such as a referring physician), a term relating to the customer's status or condition (such as age or mental health), etc. Each document can further be labeled with metadata, such as, in the case of medical patient records, diagnostic codes, procedures codes, patient codes, etc. The search terms can then include such metadata, full text, and structured data. If the search is local, only local documents are searched and if the search is global, all permitted documents are searched. In certain embodiments, the user can elect to perform a limited search (such as a search encompassing local documents relating to a single practitioner only) as a third option. The results are then returned to the user. In some embodiments, full text searching of some or all documents is also enabled. In certain embodiments of the present invention, step 216 is omitted.

Whether the first customer and the second customer are the same person can be determined by many methods. For example, only the customers'names or the customers'social security numbers can be compared. A single comparison sharply increases the risk of error. For example, if only social security numbers are used, a transcription error can result in data relating to two different persons being combined. Similarly, many people have common names (such as “John Smith”), while slight errors in recording less common names can result in the same person being treated as two people. Using only name and social security number decreases the risk of inappropriately combining data but increases the risk of treating individual persons as multiple entities. Nevertheless, this latter method is a sufficient method for the purposes of the present invention in many contexts.

An improved method utilizes current and historical information as well, such as one or more of the customer's former names (if any), current and former address, secondary address, current and former telephone number, secondary telephone number, secondary e-mail address, and current and former e-mail address. One of the difficulties of utilizing information such as a customer's address for purposes of determining a customer's identity is that customers tend to move frequently, change telephone numbers frequently, etc. Nevertheless, if a customer's complete address history is matched against another person's complete address history and those address histories substantially match, the likelihood that the two persons are the same is extremely high if they also have the same social security number (or the same name and a social security number that is the same but for one digit or two transposed digits). In addition, or in the alternative, biorhythmic data, such as fingerprints, handprints, retinal scans, etc. can be used to aid in matching, and a historical log of such data can be kept to increase the likelihood that a useful sample will be available on file for matching.

In a preferred embodiment if the first customer and the second customer are initially determined to be the same customer, but are later determined to be different customers, any records or database entries indicating such false identity are corrected, any false matches or shares are broken, and any incorrectly shared documents are segregated. The first and second customer can be incorrectly determined to be the same customer due to a failure of an algorithm for matching customers, a transcription or other input error, etc. Incorrectly shared documents can be segregated, for example, by marking such documents as being of a different worktype.

In step 218, access is granted to the published document or documents if the first customer is the same person as the second customer. Access can be granted though granting a database permission or by sending a link to the published document or documents to the second business (or even by sending actual copies of the published documents to the second business). If it has been established that both the first and second businesses are members of an existing Circle Of Sharing in step 212, then not only is access to the current published document or documents granted to the second business, but also access to past and future published document or documents published by the first business with respect to the first customer, to the extent such document or documents were (or are) unrestricted by the authoring business. Indeed, access to past and future published document or documents published by any member of the Circle Of Sharing is granted to the second business and reciprocal rights are granted to the first business. If it has not been established that both the first and second businesses are members of an existing Circle Of Sharing in step 212 (but the first customer is a common customer of the first and second businesses), then access is granted to the published document or documents only.

In certain embodiments hereunder, until a document has been shared with another business through a grant of access as described in this step 218 or otherwise, that document can be marked as restricted or otherwise made unavailable for sharing through the grant of access. Once a grant of access has occurred, however, the grant is irrevocable and subsequent sharing cannot be prevented other than through voluntary means. In other embodiments, grants of access are revocable if shared documents have not been accessed even if already shared. In other embodiments, grants of access are not irrevocable. In yet other embodiments, once a document has been published it is irrevocably available for sharing.

If after a Circle Of Sharing is created and documents are published in the secure medium, the Circle Of Sharing ceases to exist for any reason (such as the withdrawal of the participating businesses due to their common customer's revocation of consent to share data), the published documents will cease to be shared to businesses that do not already have rights to them. If thereafter, one or more new businesses join a Circle Of Sharing with respect to such customer, such new business or businesses will remain unable to access the previously shared documents by means of the Circle Of Sharing. However, if one or more previously participating businesses rejoin a Circle Of Sharing with respect to such customer, the previously published documents (to the extent unrestricted) will be shared among any previously participating businesses and any other businesses also joining the Circle Of Sharing.

In certain embodiments hereunder, specific businesses, or specific users at specific businesses, or entire classes of users or businesses can be granted limited rights with respect to specific documents or classes of documents. In such embodiments, it is necessary to verify that each user has the requisite rights to perform the intended action on a document before granting permission to do so. For example, in one embodiment, hospital laboratories are granted only limited rights with respect to documents relating to their own customers: such laboratories are only permitted to load documents (such as laboratory results) to the secure medium, but not to view other documents relating to the same patients. In that embodiment, pharmacies, on the other hand, are permitted to view documents relating to their customers loaded by other businesses (e.g., portions of the customers'patient records containing lists of medications currently or previously prescribed for the patient, medical conditions affecting the customers, and possible drug allergies suffered by the customers) but are not permitted to load documents to the secure medium.

In certain embodiments hereunder, with respect to each action taken by a user with respect to the system, a log of such action is maintained to ensure that an audit trail exists. For example, in a medical records implementation of the present invention, it is desirable to be able to determine after the fact what records any particular user inspected or created and any document attributes that may have been altered, who viewed the records of a particular patient, what access rights a particular user was granted, and who granted a particular user access rights.

In certain embodiments hereunder, a business can grant access to its customers to view their data. A business can grant such access by, for example, (a) permitting a customer to view the results of a database query returning data relating only to that customer on a computer terminal (taking any security measures necessary to prevent the customer from viewing other customers'data, such as locking the terminal or applicable software program), (b) downloading a copy of the data relating to the customer to a floppy disk, CD-ROM, DVD, or other form of storage, or downloading a copy of the data to a computer belonging to the customer, or (c) providing the customer with a user ID sufficient to allow the customer to access that customer's data. The business can provide data either on a local basis (i.e. data relating only to such business) or on a global basis (i.e. all data relating to such customer to which the business has access, even if it relates to other businesses). In yet other embodiments, a customer can be granted a system-wide user ID to access data relating to such customer on a global or more restricted basis.

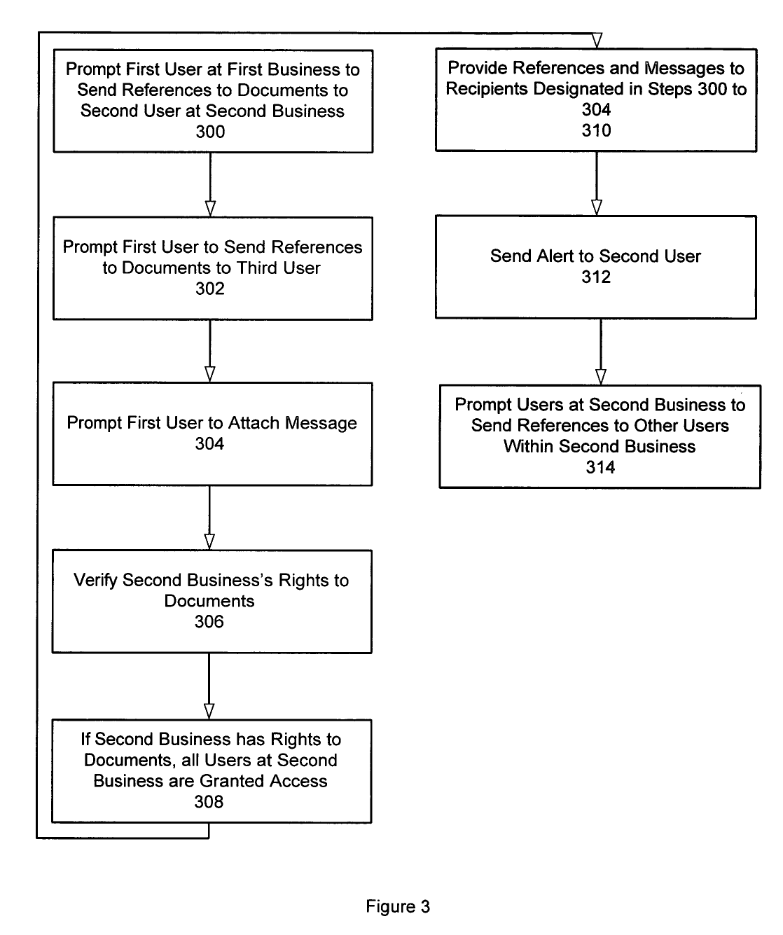

Referring to FIG. 3, a flow chart illustrating a second method in accordance with a preferred embodiment of the present invention is set forth. In step 300, a first user at a first business is prompted to send one or more references to one or more documents relating to a first customer of a first business to a second user at a second business. In some embodiments hereunder, the user is only granted the option to send a reference to a single document.

In step 302, the first user is prompted to send the one or more references to one or more documents relating to the first customer to a third user. The third user can be located at either the second business or a third business. Step 302 can be repeated as many times as desired. In some embodiments hereunder step 302 is omitted.

In step 304, the first user is prompted to attach a message to the one or more references being sent. The first user can optionally be prompted to attach a separate message to each user receiving the references in step 302. In some embodiments hereunder step 304 is omitted.

In step 306, the second business's rights to the document or documents are verified. In certain preferred embodiments hereunder, the second business has rights to documents if the documents relate to a customer of the second business. Whether the first customer is a customer of both the first and second businesses can be determined as described above in connection with the method illustrated in FIG. 2.

In step 308, if the second business has rights to the document or documents, all users at the second business are granted access to the document or documents. Similarly, if references to such document or documents have been sent to users at other businesses, this step is performed with respect to such businesses. In some embodiments hereunder, all users are not granted access to the document or documents even if the second business has rights to the document or documents unless a profile has been created in the second business's database relating to the customer to which such document or documents relate.

In step 310, the reference or references and any attached messages are provided to the users to whom they were sent in steps 300 through 304. Regardless of whether the businesses with which such users are associated have rights to the first customer, such users can view the messages and the documents to which the references relate. If the businesses have rights to the documents, then all users at such businesses can access such documents. The businesses have rights to the documents if the businesses have one or more common customers (in some embodiments one or more common customers set up in their respective databases) to which the documents relate, for example if they belong to one or more Circles of Sharing. If the businesses lack rights to the documents at the time but acquire them later, then all users at such businesses can access such documents when such businesses acquire such rights. Optionally, whether the recipient user or users have viewed the reference or references can be recorded. In some embodiments, this information is provided with respect to local users only; in other embodiments, this information is available globally.

In step 312, an alert is sent to the second user that the one or more references have been sent. This alert can be a facsimile, page, e-mail, automated telephone call, text message, short message service (sms), or other form of alert. In some embodiments hereunder step 312 is omitted.

In step 314, in certain embodiments hereunder, users at the second business are prompted to send the one or more references to other users at the second business if the second business has rights to the documents to which the one or more references relate. Optionally, such one or more references can be combined with one or more references to documents authored at such second business, or received from other sources.

In certain embodiments hereunder, the second user upon receiving the one or more references and any attached messages, is prompted to add automatically each customer to whom the one or more references relate as customers of the second business. Thus, for example, if a referring business sent references to documents relating to one or more customers being referred to a second business, the second business could be prompted to add such one or more customers into its computer system without the need for manual data entry, allowing full data sharing before the referred customer or customers first visit the second business.

In certain embodiments hereunder, each business can be prompted to establish a profile that identifies a recipient of references to documents and messages with respect to each customer of the business. Thereafter, other businesses can route references to documents and other messages to a general electronic address corresponding to such business, rather than a specific user at the business, and the references and other messages will be rerouted automatically. If the user then becomes temporarily or permanently unavailable, the references and other messages can be rerouted to another user, or rerouted among several users.

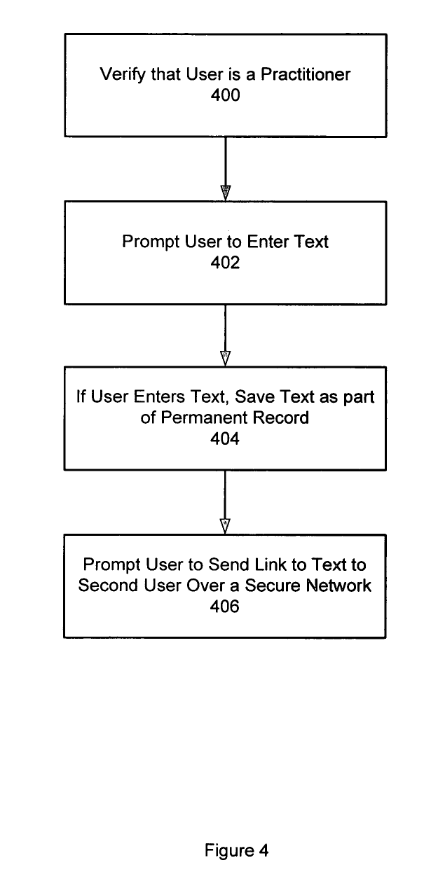

Referring to FIG. 4, a flow chart illustrating a third method in accordance with a preferred embodiment of the present invention is set forth. In step 400, it is verified that the user is a practitioner. This verification can be accomplished by comparing login and password (or biometric or other) information to verify that the user is on a previously stored list of practitioners. In step 402, the practitioner is prompted to enter text. Step 402 can be accomplished by presenting the practitioner with a standard text box in a user interface or customized user templates in a user interface. In step 404, the practitioner is prompted to submit the text as a portion of a permanent record. This permanent record can be a patient record. For example, the practitioner can be prompted to add the text to a patient's record as a note, prescription, laboratory requisition, etc. The practitioner can be provided with a list of patients or a search mechanism for selecting patients, such as by typing in names or other identifying information. In step 404, if the practitioner submits the text, the text is saved as a portion of the permanent record. In step 406, the practitioner is prompted to send a link to the text to a second practitioner, pharmacy, laboratory, etc. over a secure network.

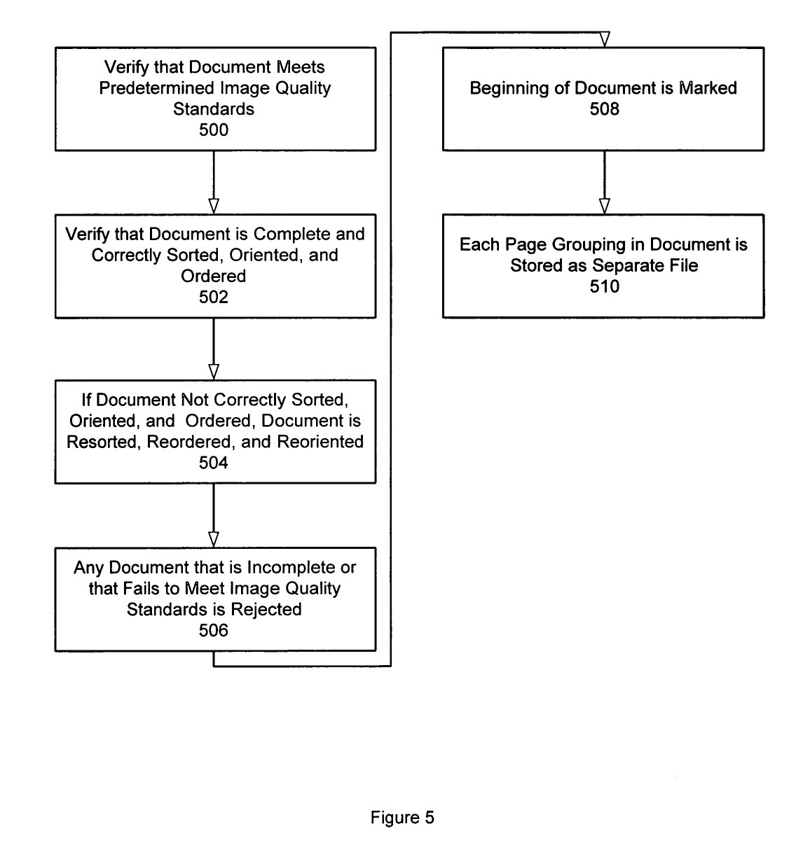

Referring to FIG. 5, a flow chart illustrating a fourth method in accordance with a preferred embodiment of the present invention is set forth. In step 500, it is verified that a document meets predetermined image quality standards. In step 502, it is verified that the document is complete and correctly sorted, ordered, and oriented. In step 504, if the document is not correctly sorted, ordered, and oriented, it is resorted, reordered, and reoriented. In step 506, any incomplete document or document failing to meet the predetermined image quality standards is rejected. In step 508, an indication is marked at the beginning of the document. In step 510, each page grouping from the first page of the document to but not including the first page of the following document is stored as a separate file with an identifier relating to the relevant customer.

Appendix A includes selected documentation relating to one possible implementation of certain aspects of the present invention and is incorporated herein by reference. Its inclusion is not intended in any way to restrict the scope of the present invention, but merely to provide additional guidance as to how some aspects of the present invention can be implemented.

The present invention may be embodied in other specific forms without departing from the spirit or essential attributes of the invention. Accordingly, reference should be made to the appended claims, rather than the foregoing specification, as indicating the scope of the invention.

That which is claimed is:

1. A method of delivering documents electronically, comprising the steps of:
(a) Prompting a first user at a first business to send a reference to a document to a second user at a second business over a secure network;
(b) Verifying that the second business has rights to the document; and
(c) Granting all users at the second business access to the document if the second business has rights to the document.

2. The method of claim 1, further comprising the step of:
(d) If the second business lacks rights to the document, but later acquires rights to the document, granting all users at the second business access to the document at the time that the second business acquires rights to the document.

3. The method of claim 1, wherein the second business has rights to the document if the document relates to a customer of the second business.

4. The method of claim 1, further comprising the steps of:
(d) Prompting the first user to send a reference to the document to a third user at the second business over the secure network; and
(e) Granting all users at the second business access to the document if the second business has rights to the document.

5. The method of claim 1, further comprising the steps of:
(d) Prompting the first user to send a reference to the document to a third user at a third business over the secure network;
(e) Verifying that the third business has rights to the document; and
(f) Granting all users at the third business access to the document if the third business has rights to the document.

6. The method of claim 1, further comprising the step of:
(d) Providing an alert to the second user that the reference to the document has been sent.

7. The method of claim 6, wherein the alert is sent by at least one of page, facsimile, automated telephone call, text-messaging, sms (short message service), or e-mail.

8. The method of claim 1, further comprising the step of:
(d) Prompting the first user to send a text message associated with the reference to the document.

9. The method of claim 1, further comprising the step of:
(d) Sending a reference to the document to a third user over a secure network,
wherein the third user is a user temporarily fulfilling the duties of the second user.

10. The method of claim 1, wherein the secure network is a world wide web based application.

11. The method of claim 1, wherein the secure network is an application service provider based application.

12. The method of claim 1, wherein the secure network is a local area network.

13. The method of claim 1, wherein the second user is a practitioner and the document relates to a patient.

14. The method of claim 1, further comprising the step of:
(d) Prompting a third user at the second business to send a reference to the document to a fourth user at the second business over the secure network if the second business has rights to the document.

15. The method of claim 1, wherein the second user is dynamically determined based on a profile.

16. A method of delivering documents electronically, comprising the steps of:
(a) Prompting a first user at a first business to send references to a plurality of documents to a second user at a second business over a secure network;
(b) Verifying that the second business has rights to each of the plurality of documents; and
(c) Granting all users at the second business access to each document to which the second business has rights.

17. The method of claim 16, further comprising the steps of:
(d) Prompting the first user to send the references to one or more additional users at the second business; and
(e) Sending the one or more additional users at the second business access to each document to which the second business has rights.

18. The method of claim 16, further comprising the step of:
(d) Granting additional users at the second business access to each document to which the second business has rights.

19. The method of claim 16, wherein the second business has rights to a document if the document relates to a customer of the second business; and
wherein each of the plurality of documents relates to the same customer.

20. The method of claim 16, wherein the second business has rights to a document if the document relates to a customer of the second business; and
wherein each of the plurality of documents does not relate to the same customer.

21. A method of delivering documents electronically, comprising the steps of:
(a) Prompting a first user at a first business to send a reference to a document to a second user at a second business over a secure network;
(b) Verifying that the second business has rights to the document;
(c) Granting all users at the second business access to the document if the second business has rights to the document; and
(d) If the second business does not have rights to the document, granting limited access to the second user only to the document.

22. A method of creating notes, comprising the steps of:
(a) Verifying that a user is a practitioner;
(b) Prompting the practitioner to enter text;
(c) Prompting the practitioner to submit the text as a portion of a permanent record; and
(d) If the practitioner submits the text, saving the text as a portion of a permanent record.

23. The method of claim 22, further comprising the step of:
(e) Prompting the practitioner to send a link to the text to a second practitioner over a secure network.

24. The method of claim 22, wherein the practitioner is a medical professional and the permanent record is a patient's medical chart.

25. The method of claim 22, wherein step (d) comprises converting the text to a standardized format before saving the text.

26. A method of segregating data within a file into distinct patient documents, comprising the steps of:
(a) Identifying the beginning of each document by searching for one or more predetermined phrases; and
(b) Storing each document.

27. A method of categorizing documents, comprising the steps of:
(a) Verifying that a document meets predetermined image quality specifications;
(b) Verifying that the document is complete and correctly sorted, ordered, and oriented;
(c) Resorting, reordering, and reorienting any incorrectly sorted, ordered, or oriented document;
(d) Rejecting any incomplete document or any document failing to meet predetermined image quality specifications;
(e) Marking an indication relating to a customer at the beginning of the document; and
(f) Storing each page grouping from the first page of the document to but not including the first page of the following document as a separate file with an identifier relating to the customer.

28. The method of claim 27, wherein step (a) is performed by visual inspection.
